(19) United States
(12) Patent Application Publication
(10) Pub. No.: US 2026/0316099 A1
(43) Pub. Date: Oct. 15, 2026

(54) FAUCET WITH FLIP FACE SPRAY HEAD

(71) Applicant: Karran USA, LLC, Vincennes, IN (US)

(72) Inventor: Todd Alexander, Vincennes, IN (US)

(21) Appl. No.: 19/465,435

(22) Filed: Jan. 30, 2026

Related U.S. Application Data
(60) Provisional application No. 63/751,517, filed on Jan. 30, 2025.

(51) Int. Cl. B05B 7/04; B05B 1/16; E03C 1/084

(52) U.S. Cl. CPC B05B 7/0425; B05B 1/1636; E03C 1/084

(57) ABSTRACT

A spray head for a faucet includes an outer shell and a spray face. The spray face includes an inner aerator positioned within an outer aerator. The outer aerator is positioned within a holder ring. The inner aerator includes an inner disc that is configured to rotate between a first position and a second position on the spray face. The outer aerator includes an outer disc that is also configured to rotate between a first position and a second position on the spray face. The spray face provides a different spray pattern depending on the rotational position of inner disc and the outer disc on the spray head.

### CROSS-REFERENCE TO RELATED APPLICATIONS

The present application claims priority to U.S. provisional patent application No. 63/751,517, filed Jan. 30, 2025, the entire contents of which are incorporated by reference herein.

### FIELD

The present disclosure relates to faucets and particularly to faucet spray heads with aerators.

### BACKGROUND

Aerators for faucets are known. Faucet aerators typically take the form of a small, round mesh-screen device that is screwed onto the face/tip of the faucet where water is dispensed. The aerator is designed to conserve water while also creating a more consistent, splash-free stream of water that is aesthetically pleasing and gentle to the touch. Aerators mix water and air in order to make the water stream smoother.

While the primary purpose of an aerator is to conserve water, the aerator can also act as a filter by catching particulate matter within the water stream, such as grit or scale. For this reason, aerators may need to be periodically cleaned by removing the aerator from the faucet and performing a flushing operation in order to remove any particulate matter caught in the aerator. If particulate matter is not removed from the aerator, the particulate matter can interfere with the water stream and interrupt the intended flow of water from the face of the faucet.

While aerators are designed to be periodically cleaned, in practice, few individuals regularly clean aerators on their faucets. As a result, particulate matter may remain trapped within the aerator, thus resulting in a reduced flow of water through the aerator and/or a water flow that is not as smooth and aesthetically pleasing as intended.

In view of the following, it would be advantageous to provide a faucet with an aerator that is configured for quick and convenient cleaning. It would also be advantageous if such aerator were configured to offer additional versatility for the user of the faucet. Moreover, it would be advantageous if all of the above could be offered in a faucet that is relatively inexpensive and easy to manufacture.

### SUMMARY

A spray head for a faucet includes an inner aerator arranged within a mount. The inner aerator and mount are further arranged within an outer aerator. The inner aerator is rotatable between a first position that produces a first spray pattern and a second position that produces a second spray pattern. The inner aerator may also be released from the mount. The outer aerator is rotatable between a first position wherein the inner aerator is used to provide a spray pattern (i.e., either the first or second spray pattern) and a second position wherein the outer aerator is used to provide a third spray pattern.

In at least one embodiment, a spray head for a faucet includes an outer shell, an aerator cavity defined within the outer shell, and an aerator plate positioned within the aerator cavity. The aerator plate includes a first spray face and a second spray face opposite the first spray face. The aerator plate is configured to be flipped between a first position exposing the first spray face and a second position exposing the second spray face without removal of the aerator plate from the aerator cavity.

In at least one embodiment, a spray head for a faucet includes an outer shell, a cavity defined within the outer shell, and an outer aerator arranged within the cavity. The spray head further includes an inner aerator nested within the outer aerator.

In at least one embodiment, a spray head is associated with a method of providing different spray patterns. The method includes spraying water from a first spray face of an aerator positioned within the spray head, wherein the water sprayed from the first spray face of the aerator has a first spray pattern. The method further includes rotating the aerator without removing the aerator from the spray head to expose a second spray face of the aerator. Thereafter, the method includes spraying water from the second spray face of the aerator positioned within the spray head, wherein the water sprayed from the second spray face of the aerator has a second spray pattern.

The above-described features and advantages, as well as others, will become more readily apparent to those of ordinary skill in the art by reference to the following detailed description and accompanying drawings. While it would be desirable to provide a spray head that provides one or more of these or other advantageous features as may be apparent to those reviewing this disclosure, the teachings disclosed herein extend to those embodiments which fall within the scope of any eventually appended claims, regardless of whether they include or accomplish one or more of the advantages or features mentioned herein.

### BRIEF DESCRIPTION OF THE DRAWINGS

FIG. 1 shows a front perspective view of a flip face spray head for a faucet;

FIG. 2 shows a top/front view of the spray head of FIG. 1;

FIG. 3 shows a bottom/face view of the spray head of FIG. 1;

FIG. 4 shows a side view of the spray head of FIG. 1;

FIG. 5 shows a cross-sectional view of the spray head through line V-V of FIG. 2;

FIG. 6 shows another cross-sectional view of an inner aerator of the spray head in isolation from other components of the spray head, which inner aerator is identified by dotted line box VI in FIG. 5;

FIG. 7 shows a bottom perspective view of the inner aerator including an aerator disc in a mount of the spray head of FIG. 1, the inner aerator in isolation from other components of the spray head;

FIG. 8 shows a perspective view of the aerator disc of FIG. 7 being rotated within the mount;

FIG. 9 shows a perspective view of the aerator disc of FIG. 7 aligned with two opposing notches in a face of the mount;

FIG. 10 shows a perspective view of the aerator disc of FIG. 9 released from the mount after sliding through the notches in the face of the mount;

FIG. 11 shows a perspective view of a face of the spray head of FIG. 1 with the inner aerator and mount positioned within an outer aerator of the spray head, the outer aerator including an aerator disc within a mount;

FIG. 12 shows a perspective view of the outer aerator disc of FIG. 11 at the start of a rotation process to expose an opposite side of the outer aerator disc;

FIG. 13 shows a perspective view of the outer aerator disc of FIG. 12 near a mid-point of the rotation process;

FIG. 14 shows a perspective view of the outer aerator disc of FIG. 13 near the end of the rotation process with a perforated face of the outer aerator disc exposed on the spray head;

FIG. 15 shows perspective view of an alternative embodiment of the spray head of FIG. 1 including dotted lines illustrating the positions of an inner aerator disc positioned within an outer aerator disc on the face of the spray head;

FIG. 16 shows a perspective view of the spray head of FIG. 15 with a first spray pattern of water coming from the face when the inner aerator disc of the spray head is in its first rotational position and the outer aerator disc of the spray head is in its first rotational position;

FIG. 17 shows a perspective view of the spray head of FIG. 15 with the inner aerator disc in the process of rotation from the first rotational position to a second rotational position;

FIG. 18 shows a perspective view of the spray head of FIG. 15 with the inner aerator disc rotated to the second rotational position;

FIG. 19 shows a perspective view of the spray head of FIG. 15 with a second spray pattern of water coming from the face when the inner aerator disc of the spray head is in its second rotational position and the outer aerator disc of the spray head is in its first rotational position;

FIG. 20 shows a perspective view of the spray head of FIG. 15 with the outer aerator disc in the process of rotation from the first rotational position to a second rotational position;

FIG. 21 shows a perspective view of the spray head of FIG. 15 with the outer aerator disc in the second rotational position;

FIG. 22 shows a perspective view of the spray head of FIG. 15 with a third spray pattern of water coming from the face when the outer aerator disc of the spray head is in its second rotational position; and

FIG. 23 shows a perspective view of the spray head of FIG. 15 with the outer aerator disc in the process of rotation from the second rotational position back to the first rotational position.

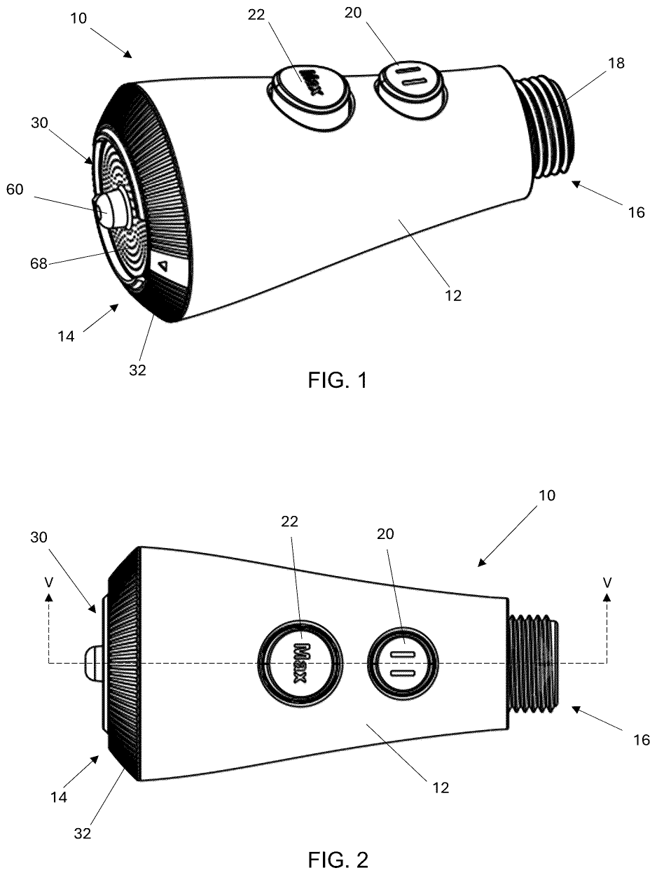

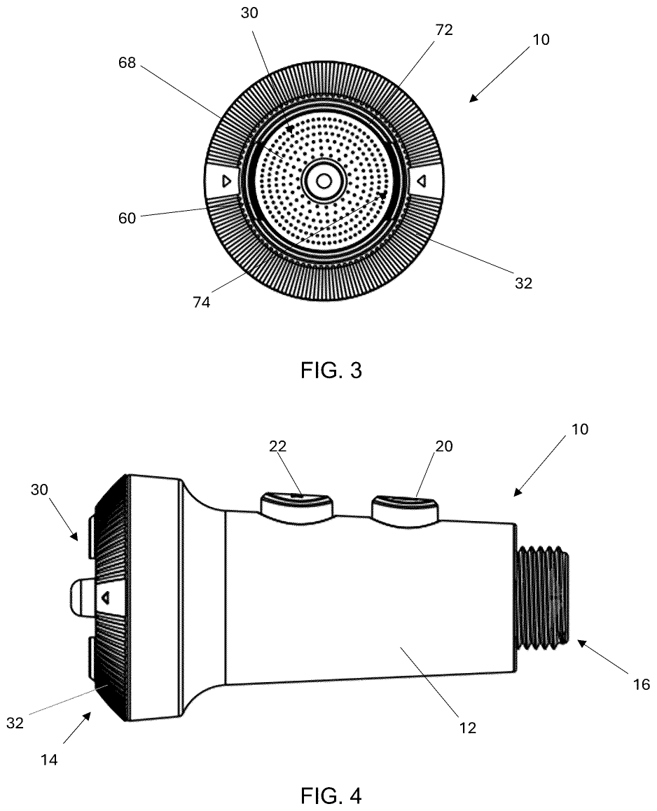

### DESCRIPTION

With reference now to the figures, a spray head 10 for a faucet is shown, and particularly a spray head for a kitchen sink faucet. The spray head 10 includes an outer shell 12, toggle switches 20, 22, and a spray face 30. The spray face 30 is selectively provided by an inner aerator 40 or an outer aerator 60, the inner aerator 40 being positioned within and retained by the outer aerator 60. The outer aerator 60 is positioned within a cavity in the outer shell 12 of the spray head 10 and retained behind a holder ring 32 on the spray end 14 of the outer shell 12 of the spray head 10. The inner aerator includes 40 a first aerator plate in the form of an inner aerator disc 42 configured to rotate between a first position and a second position on the spray face. The outer aerator 60 includes a second aerator plate in the form of an outer aerator disc 62 that is also configured to rotate between a first position and a second position on the spray face. The spray pattern produced at the spray end 14 of the spray head 10 is different depending on the rotational position of the inner disc 42 and the outer disc 62.

While a kitchen faucet is disclosed and illustrated in the figures, it will be recognized that the term “faucet” is not limited to kitchen faucets, and is intended to refer to any a fixture configured to draw or regulate the flow of liquid from a hose or pipe, including bathroom faucets, shower faucets, outdoor spigots, etc. Similarly, the term “spray head” as used herein is not limited to a spray head for use in association with a kitchen faucet, but further includes shower spray heads, bathroom spray heads, garden nozzle spray heads for connection to a garden hose, as well as any number of other spray heads that are used in association with other types and locations of faucets.

### General Construction of the Spray Head

The outer shell 12 of the spray head 10 is configured to direct water from a water source to a water outlet on the spray head. Accordingly, the spray head 10 includes a hose end 16 with a threaded coupling that is configured for connection to a water hose, and a spray end 14 that is configured to dispense water from the outer shell 12. The outer shell 12 may be comprised of any appropriate material for directing water therethrough, such as stainless steel, plastic, zinc alloys, brass, or any of various other materials as may be recognized by those in the art.

The outer shell 12 is designed and dimensioned to be easily and comfortably grasped and manipulated by a human hand. Accordingly, in at least some embodiments, such as those shown in the figures, the spray head 10 has a somewhat conical shape with a relatively larger diameter near the spray end 14 and a narrower diameter near a hose end 16. The spray head 10 may gradually taper along the length of the outer shell 12 between the spray end 14 and the hose end 16. The face 30 of the spray head 10 is provided at the spray end 14 of the spray head 10, and a threaded coupling 18 is provided at the hose end 16 of the spray head 10.

The toggle switches 20, 22 are positioned in axial alignment on the spray head 10 between the spray end 14 and the hose end 16 of the outer shell. The toggle switches 20, 22, are configured to control a flow of water from the hose end 16 to the spray end 14 of the spray head 10. The toggle switches include a proximal toggle switch 20 closer to the hose end 16 and a distal toggle switch 22 closer to the face 30. The proximal toggle switch 20 is used to turn on and off the stream of water flowing from the water source and through the spray head 10. The distal toggle switch 22 is configured to incrementally either increase or decrease the amount of water emitted from the face 30 when water is flowing through the spray head 10.

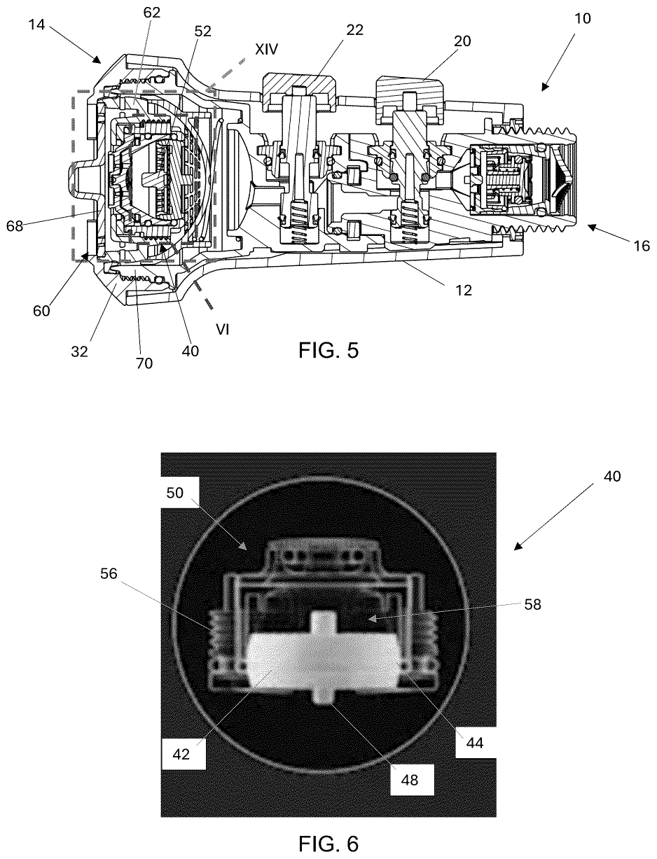

As shown in FIG. 5, the spray head 10 includes an inner aerator 40 (identified by the dotted line box identified as “VI”) including an inner aerator plate provided by disc 42, and an outer aerator 60 (identified by the dotted line box identified as “XIV”) including an outer aerator plate provided by disc 62. The word “plate” as used herein refers to a structure that includes a first side and a second side, has greater width and depth dimensions than height dimension. A “plate” may be provided in any number of different sizes and shapes. The word “disc” as used herein refers to a plate that is generally round (i.e., a diameter defines the width and depth dimensions) and includes a generally flat first side and opposing second side (wherein the height dimension of the disc is a distance between the first side and the second side).

The inner aerator 40 is completely retained by/nested within the outer aerator disc 62. In the configuration of FIG. 5, the outer aerator disc 62 provides the spray face 30 for the spray head 10 and the inner aerator 40 is completely shrouded by the outer aerator 60 (i.e., the inner aerator 40, including the inner aerator disc 42, is not visible on the exterior of the spray head 10). However, as explained in further detail below, the outer aerator disc 62 is rotatable and may be flipped to expose the inner aerator disc 42 and allow one of the faces of the inner aerator plate 42 to provide the spray face 30 for the spray head 10. To this end, the inner aerator disc 42 is also completely reversable/rotatable within the outer aerator 60.

### Inner Aerator

With reference now to FIGS. 6-10, the inner aerator 40 is shown in isolation from the outer aerator 60. The inner aerator 40 includes an inner aerator disc 42 that is releasably retained within a mount 50 of the inner aerator. The inner aerator disc 42 is defined by a circular outer wall 44, a first perforated face 45, a second perforated face 46, and a center post 48 that extends along a center axis of the disc. The circular outer wall 44 has a convex shape defined by a radius. Accordingly, the outer wall 44 is outwardly bulging between the first perforated face 45 and the second perforated face 46. The first perforated face 45 is flat and is defined by a first arrangement of small holes designed to create a first spray pattern for the faucet. The first perforated face 45 provides the spray face 30 for the spray head 10 when exposed within the center of the holder ring 32 on the spray end 14 of the spray head 10. The second perforated face 46 is also flat and is defined by a second arrangement of small holes designed to create a second spray pattern for the faucet. The second perforated face 46 provides the spray face 30 for the spray head 10 when exposed within the center of the holder ring 32 on the spray end 14 of the spray head 10. The center post 48 projects slightly axially outwardly from the disc 42 at the center of both the first perforated face 45 and the second perforated face 46. The center post 48 may also be considered to be a small protuberance or nipple on each of the first and second perforated faces 45, 46.

The inner aerator disc 42 may be rotated (i.e., flipped) within the mount 50 without removal of the disc 42 from the mount 50. As explained in further detail below, a first spray pattern is produced when the first perforated face 45 is outwardly facing on the spray head 10 and provides the first spray face. Likewise, a second spray pattern is produced when the second perforated face 46 is outwardly facing on the spray head 10 and provides the second spray face. In each position, the inner aerator 40 is configured to mix water with air and produce a smooth, consistent, splash-free stream of water.

The mount 50 that holds the inner disc 42 includes a slotted circular rim 52, a cylindrical outer wall 56, and a cavity 58 formed within the outer wall 56. The cylindrical outer wall 56 of the mount 50 is threaded on an exterior surface and generally smooth on an interior surface. The slotted circular rim 52 defines a center opening 55 in the mount 50 that is large enough to expose the complete first or second perforated face 45, 46, of the inner disc 42, but small enough to prevent the disc 42 from passing therethrough when one of the faces 45, 46 is exposed in the opening 55 (i.e., the bulging outer wall 44 of the disc 42 prevents passage of the dis through the opening 55).

The slotted circular rim 52 of the mount 50 includes a number of outer slots 53 located along the outer perimeter of the circular rim 52. These slots 53 are designed to receive a tool that allows the inner aerator 40 to be rotated for insertion or removal of the inner aerator 40 from the spray head. Specifically, the slots 53 allow the mount 50 to be rotated such that the threaded outer surface of cylindrical outer wall 56 engages complementary threads in the outer disc 62 of the outer aerator 60 to secure or remove the mount 50 from the outer aerator 60.

The slotted circular rim 52 of the mount 50 also includes two opposing inner notches 54 located on the inner perimeter of the center opening of the slotted circular rim 52. The opposing inner notches 54 increase the diameter of the center opening across the slotted rim 52 (i.e., the diameter of the center opening is greater when measured between the inner notches 54 than when measured between other perimeter portions of the center opening). Specifically, as explained in further detail below, the diameter of the center opening at the inner notches 54 is sufficient to create a slot within the circular rim 52 that is capable of passing the inner aerator disc 42 when the disc 42 is properly aligned with the inner notches 54.

The cylindrical outer wall 56 of the mount 50 is defined by a threaded exterior and a relatively smooth interior. The threads on the exterior of the outer wall 56 allow the mount 50 to be rotatably inserted into the outer aerator 60 of the spray head. The cavity 58 of the mount 50 is defined within the smooth interior of the outer wall 56. Similar to the outer wall 56, the cavity 58 may also have a cylindrical shape. Alternatively, the cavity may be somewhat spherical in shape. In any event, the cavity 58 is sufficiently sized to receive the aerator disc 42 and allow the aerator disc 42 to move freely therein. In particular, the inner aerator disc 42 is free-floating and rotatable within this cavity 58. Accordingly, the cavity is sufficiently sized to allow the aerator disc 42 to completely rotate from one side to another, thus allowing either the first or second perforated face 45, 46 of the aerator disc 42 to be presented through the slotted rim 52 of the mount 50.

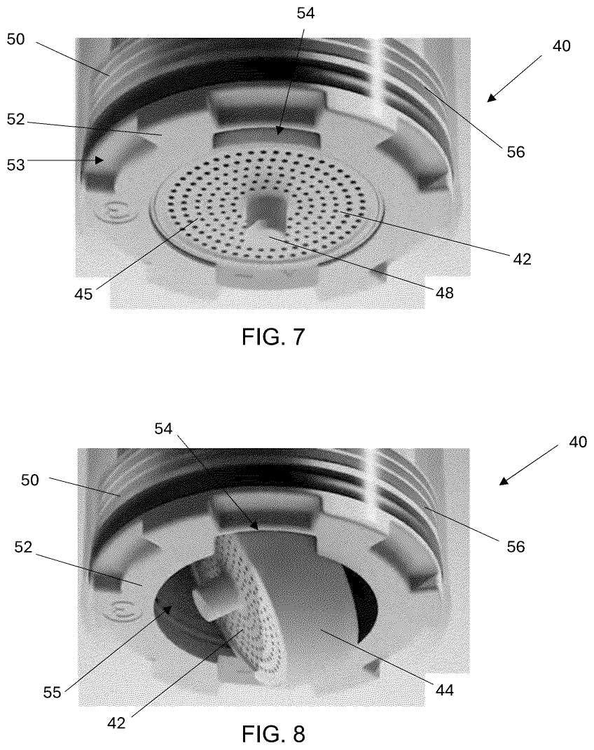

FIGS. 7-10 illustrate movement of the aerator disc 42 within the cavity 58 of the mount 50. FIG. 7 shows the aerator disc 42 positioned with the first face 45 of the aerator disc 42 exposed via the center opening of the slotted rim 52 such that the first face 45 of the disc 42 provides the spray face 30 for the spray head 10. When the disc 42 is in the position shown in FIG. 7, the convex outer wall 44 of the disc (not shown in FIG. 7; see FIGS. 8-10) prevents the disc 42 from sliding out of the mount 50 because the diameter of the convex outer wall 44 of the disc 42 is smaller than the standard diameter of the center opening of the slotted rim 52.

FIG. 8 shows the aerator disc being rotated within the cavity 58 of the mount. A full 180° rotation of the aerator disc 42 from the first face 45 flips the disc 42 and results in the opposite second face 46 of the disc 42 being exposed at the center opening of the slotted rim 52. When the second face 46 is exposed at the center opening of the slotted rim 52, this second face 46 provides the spray face 30 for the spray head 10. The spray pattern produced by the second face 46 is different than the spray pattern produced by the first face 45.

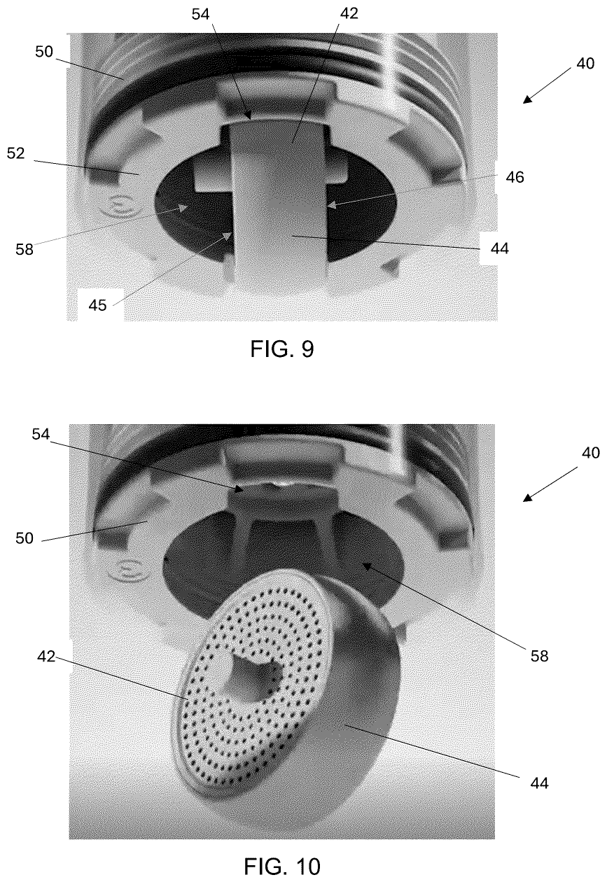

FIG. 9 shows the aerator disc 42 positioned in the cavity 58 with the convex outer wall 44 of the disc aligned with the two opposing inner notches 54 of the slotted rim 52. More specifically, FIG. 9 shows the aerator disc 42 arranged perpendicular to a plane defined by the slotted circular rim 52 (i.e., the plane defined by one of the faces 45 or 46 of the aerator disc 42 is perpendicular to the plane defined by the outer face of the slotted circular rim 52). Furthermore, FIG. 9 shows and the aerator disc 42 aligned with the two opposing inner notches 54 of the slotted rim 52. As mentioned previously, the diameter of the center opening between the inner notches 54 of the slotted rim 52 is greater than that of the outer diameter of the aerator disc. Therefore, when the aerator is in the position shown in FIG. 9, the aerator disc 42 may be completely removed from the mount 50 by sliding the aerator disc 42 through the notches 54 until it is released from the mount 50, as shown in FIG. 10. Once removed from the mount 50 and spray head 10, the aerator disc 42 may be thoroughly cleaned with a scrub brush and/or designated cleaners. The aerator disc 42 may then be re-inserted into the mount 50 in the opposite manner from which it was removed (i.e., with the faces 45, 46 of the disc oriented perpendicular to a plane defined by the rim 52 and the outer wall 44 of the disc 42 aligned with the notches such that the disc 42 may be inserted into the cavity defined within the outer wall 56 of the mount 50). Alternatively, in at least some embodiments, the aerator disc 42 may be replaced by a different aerator disc that is capable of producing completely different spray patterns for the user.

In the embodiments disclosed herein, the inner aerator 40 is retained within the outer aerator 60. The inner aerator 40 may be considered to be “nested” within the outer aerator 60 because the complete inner aerator 40 is held within the outer aerator. Thus, the term “outer aerator” as used herein is not limited to an aerator position that is completely outside of the “inner aerator,” but may also refer to such a nested arrangement wherein the inner aerator 40 (including the inner disc 42) is retained completely or partially within the outer aerator 60 (including the outer disc 62).

### Outer Aerator

The outer aerator 60 is best illustrated in FIGS. 5 and 11-14. As shown in these figures, the outer aerator 60 comprises an aerator disc 62 that is retained within a mount 70. The mount 70 of the outer aerator 60 is retained within a cavity defined within the outer shell 12 of the spray head 10 behind the holder ring 32. The inner surface of the holder ring 32 threadedly engages an outer surface of the mount 70. In some embodiments, rotation of the holder ring 32 facilitates removal of the holder ring 32 from the mount 70 on the spray end 14 of the outer shell 12. Removal of the holder ring 32 may then allow removal of the outer aerator 60 and/or outer aerator disc 62 as well as the inner aerator 40 nested within the outer aerator 60.

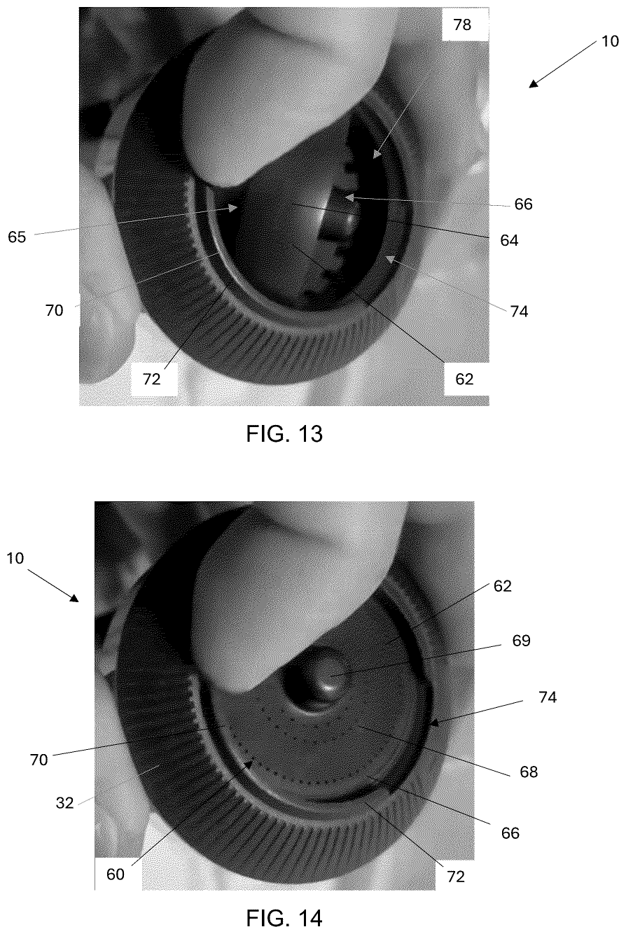

The aerator disc 62 is defined by a circular wall 64 (see FIGS. 12 and 13), a first side 65 (see FIG. 12) with a central opening 76, a second side 66 (see FIG. 14) with a perforated face 68 and a central nipple 69 that protrudes outwardly at a center of the perforated face 68. The circular outer wall 64 of the aerator disc 62 has a convex shape defined by a radius. Accordingly, the outer wall 64 is outwardly bulging between the first side 65 and the second side 66 of the disc 62. The first side of the 65 includes a center opening that receives the mount 50 of the inner aerator 40. Specifically, the center opening leads to a chamber in the disc 62 that includes complimentary threads to those on the cylindrical outer wall 56 of the mount 50. This allows the inner aerator 40 (and particularly the mount 50) to be screwed into the disc 62 of the outer aerator and retained within its chamber. The second side 66 of the disc 62 includes the perforated face 68. This perforated face 68 is defined by a third arrangement of small holes designed to create a third spray pattern for the faucet when the perforated face 68 is exposed on the spray head 10.

The aerator disc 62 is retained on the spray head 10 within the mount 70. The mount 70 includes an outer rim 72 that defines a center opening to the spray head 10. The outer rim 72 is large enough to expose the first side 65 or the second side 66 of the outer aerator disc 62, but small enough to prevent the disc 62 from passing therethrough (similar to the inner disc 42 and rim 52 of the inner aerator 40). The mount 70 is received within the outer shell 12 of the spray head 10 and defines a cavity for the outer aerator disc 62 that is sufficiently sized to allow complete rotation of the aerator disc 62 therein. Accordingly, similar to the inner aerator disc 42 and mount 50, the outer aerator disc 62 is free-floating within the mount 70, thus allowing the outer aerator disc 62 to be rotated (i.e., about the axis of the nipple 69) and/or flipped (i.e., between the first side 65 and the second side 66) without removal of the disc 62 from the mount 70 and/or the spray head 10.

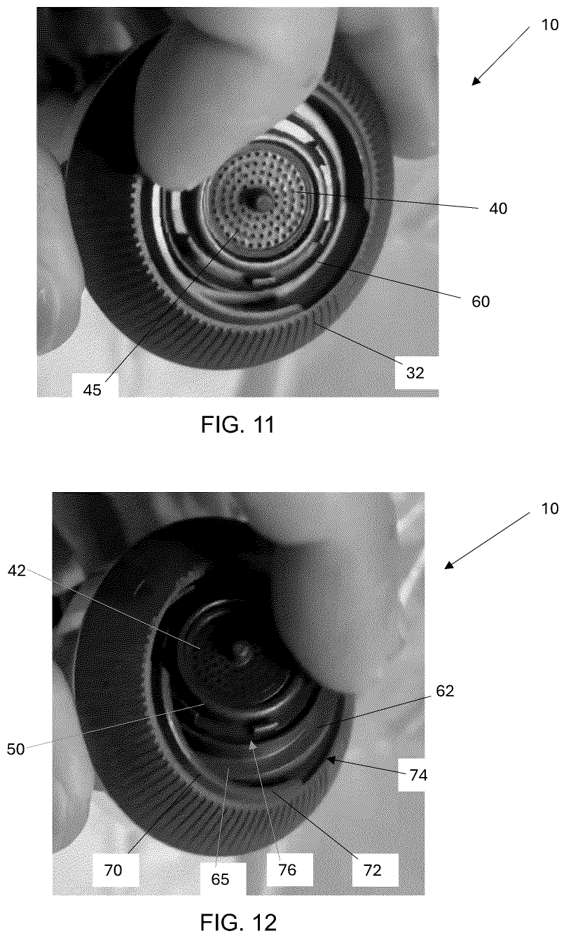

The outer rim 72 of the mount 70 includes two opposing notches 74 located along the perimeter of the outer rim 72. These notches 74 increase the diameter of the center opening across the outer rim 72 (i.e., the diameter of the center opening is greater when measured between the notches 74 than when measured between other perimeter portions of the outer rim 72). Specifically, the diameter of the center opening at the notches 74 is sufficient to create a slot in the outer rim that will pass the disc 62 when the disc 62 is properly aligned with the notches 74 (i.e., similar to the inner disc 42 and the inner notches 54, as shown in FIG. 9). As shown in FIGS. 11-14, the notches 74 also provide recesses that receive the finger of a user in order to make it easier for the user to rotate and flip the disc 62.

FIGS. 11-14 illustrate a method of manipulating the spray head 10 by movement of the outer aerator 60 within the spray head 10. FIG. 11 shows the aerator disc 62 positioned with the first side 65 of the aerator disc 42 presented at the center opening of the outer rim 72, thus exposing the inner aerator 40 on the face of the spray head 10. In this position, the inner disc 42 of the inner aerator 40 may be rotated and/or flipped, as previously described. Also, the convex outer wall 64 of the disc 62 prevents it from sliding out of the mount 70 because the outer diameter of the convex outer wall 64 is smaller than the standard diameter of the center opening of the outer rim 72. FIGS. 11 and 12 show the outer aerator disc 62 being rotated (i.e., flipped face-over-face) within the chamber 78 of the mount 70. FIG. 14 shows a full 180° rotation of the aerator disc 62 (compared to the position of FIG. 11), thus causing the perforated face 68 on the second side 66 of the aerator disc 62 to be exposed at the outer rim 72. In this position, the inner aerator 40 (which is nested within the outer aerator 60) is shrouded/concealed by the second side 66 and perforated face 68 of the outer aerator disc 62 (this is also the position shown in the cross-sectional view of FIG. 5). While not illustrated in the figures, it will be recognized that the outer aerator disc 62 may also be released from the spray head (similar to the inner aerator disc 42) by positioning the aerator disc 62 in the chamber of the mount 70 with the convex outer wall 64 of the disc 62 aligned with the two opposing notches 74 of the outer rim 72.

### Method of Selecting a Spray Pattern

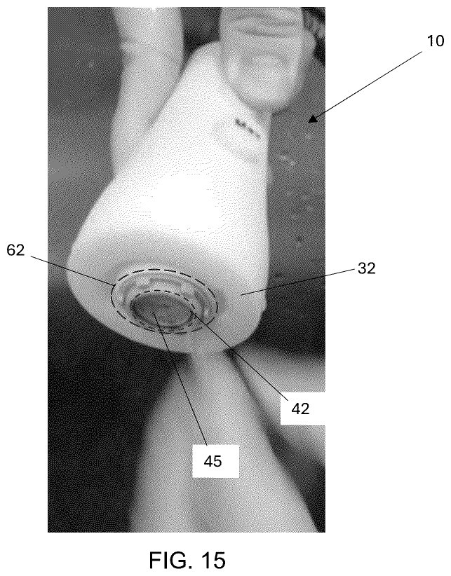

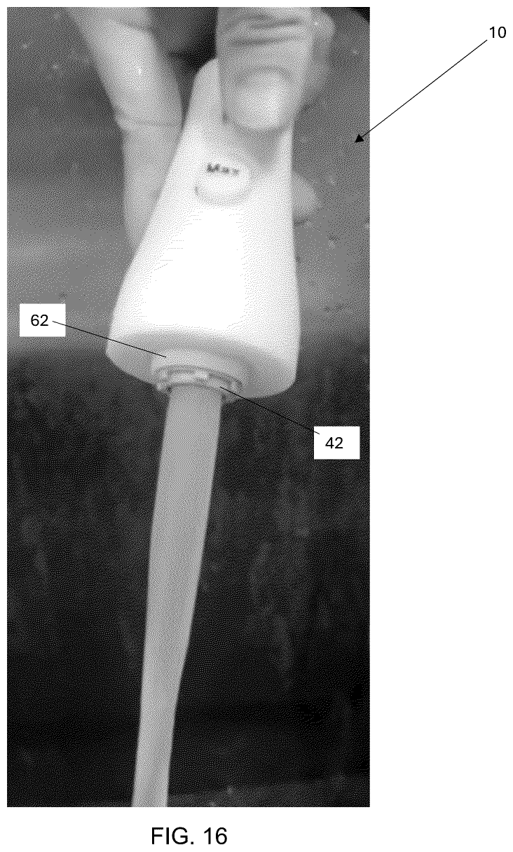

With reference now to FIGS. 15-23 a method of selecting a spray pattern is illustrated in association with operation of an embodiment of the spray head 10 disclosed herein. FIG. 15 shows the spray head 10 with the position of an inner aerator disc 42 illustrated by the inner dotted line circle and the position of an outer aerator disc 62 illustrated by the outer dotted line circle. In this position, the first perforated face 45 of the inner aerator disc 42 is shown exposed on the spray face 30. FIG. 16 shows a first spray pattern of water being dispensed from the spray face 30 when the first perforated face 45 of the inner aerator disc 42 is exposed on the spray head 10.

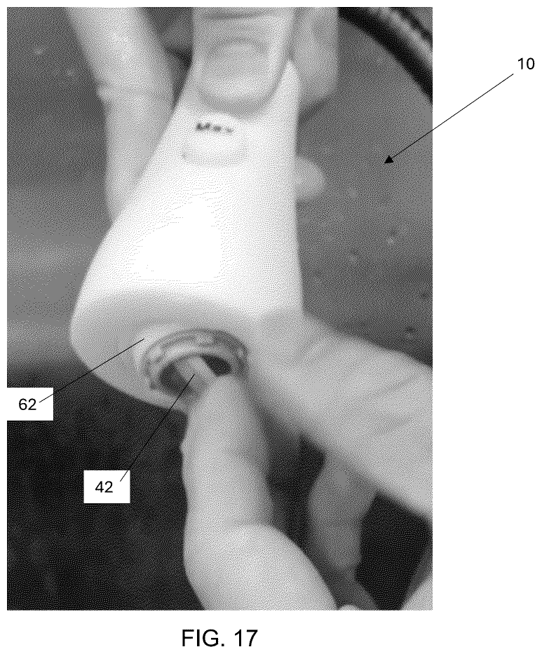

FIG. 17 shows the fingers of a user in the process of rotating the inner aerator disc 180°. Because the inner aerator disc 42 is free floating within the mount 50, this is easily accomplished by the user simply pressing on one side of the disc 42 (or the center post 48) and causing the disc to rotate within the mount 50.

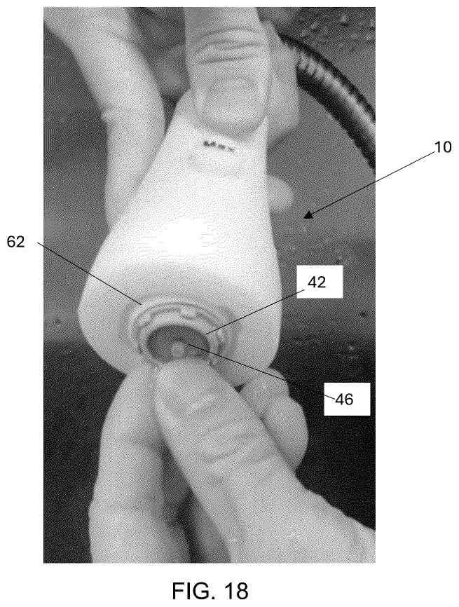

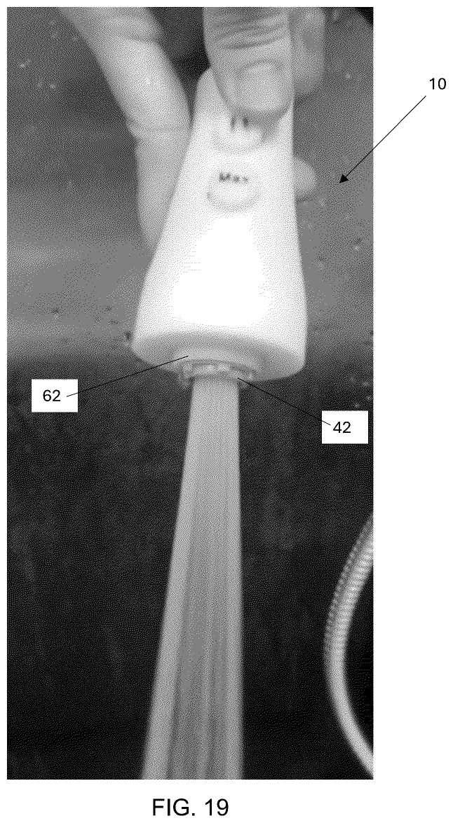

FIG. 18 shows the inner disc 42 fully rotated 180° (i.e., completely flipped) such that the second perforated face 46 is the spray face 30 exposed on the spray head 10. FIG. 19 shows a second spray pattern of water being dispensed from the spray face 30 when the second perforated face 46 of the inner aerator disc 42 is the spray face exposed on the spray head 10. It will be recognized that this second spray pattern is different than the first spray pattern.

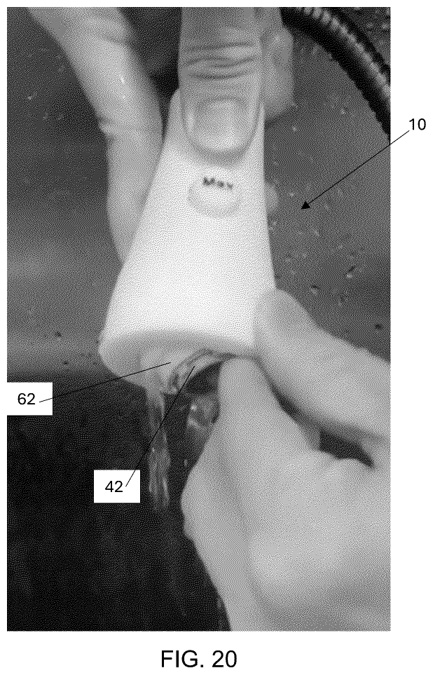

FIG. 20 shows the fingers of a user in the process of rotating the outer aerator disc 180° (i.e., flipping the disc 62) from the first side 65 to the second side 66. Because the outer aerator disc 62 is free floating within the mount 70, this is easily accomplished by the user simply pressing on one side of the disc 62 and causing the disc to rotate within the mount 50.

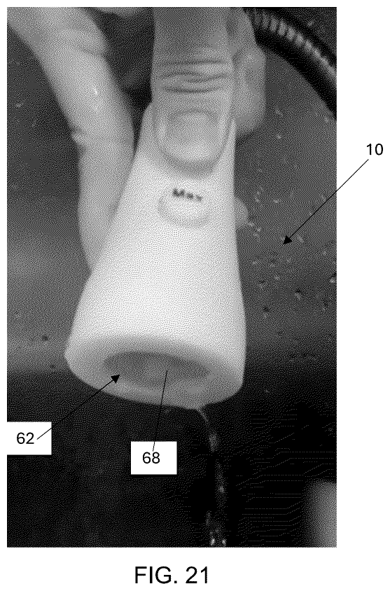

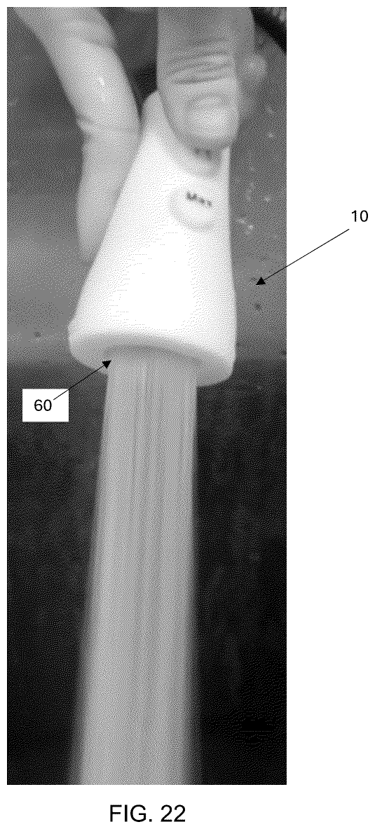

FIG. 21 shows the disc 62 fully rotated 180° (i.e., completely flipped) such that the second side 66 of the disc 62 is exposed on the spray head 10, and particularly the perforated face 68 is exposed as the spray face 30 of the spray head 10. In this position, the inner aerator 40 is shrouded and only the second side 66 of the outer aerator 60 is exposed on the spray head 10. FIG. 22 shows a third spray pattern of water being dispensed from the spray face 30 when the perforated face 68 of the outer aerator disc 62 is exposed on the spray head 10.

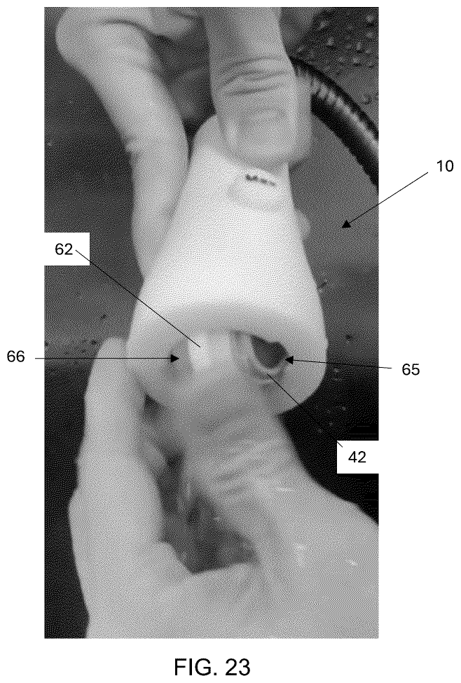

FIG. 23 shows the fingers of a user in the process of rotating the outer aerator disc 62 another 180° from the second side 66 to the first side 65. After rotating the outer aerator disc 62, either of the first or second spray patterns can be achieved again (as shown in FIGS. 16 and 19), as desired by the user.

In view of the foregoing, it will be recognized that a faucet with a flip face spray head is disclosed herein. The spray head includes at least one adjustable aerator, such as an inner aerator 40 with a rotatable aerator disc 42. The inner aerator 40 may be positioned within one or more additional adjustable aerators, such as outer aerator 60 with a rotatable aerator disc 62. In other words, the adjustable spray head may include an inner adjustable aerator disc arranged within at least one outer adjustable aerator, and each adjustable aerator may include a rotatable aerator disc positioned within a mount. The inner rotatable disc allows the user to choose a first or a second spray pattern (e.g., see FIGS. 16 and 19). The outer rotatable disc allows the user to choose an additional third spray pattern (e.g., FIG. 22), if desired.

Although the various embodiments have been provided herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed:

1. A spray head for a faucet, the spray head comprising:
an outer shell;
an aerator cavity defined within the outer shell; and
an aerator plate positioned within the aerator cavity, the aerator plate including a first spray face and a second spray face opposite the first spray face, wherein the aerator plate is configured to be flipped between a first position exposing the first spray face and a second position exposing the second spray face without removal of the aerator plate from the aerator cavity.

2. The spray head of claim 1 wherein the first spray face is a first flat perforated face configured to produce a first spray pattern, and the second spray face is a second flat perforated face configured to produce a second spray pattern.

3. The spray head of claim 2 wherein the aerator plate is an aerator disc with convex outer wall that bulges outwardly between the first spray face and the second spray face.

4. The spray head of claim 3 wherein the aerator plate is an aerator disc rotatably positioned within a mount retained within the aerator cavity, the mount including an outer wall defining a disc cavity configured to retain the aerator disc and a circular rim configured to retain the aerator disc within the disc cavity of the mount.

5. The spray head of claim 4 wherein the mount includes two opposing notches arranged on opposing sides of an inner diameter of the circular rim, wherein the two opposing notches are configured to allow the aerator disc to be removed from an interior cavity of the mount when the aerator disc is arranged perpendicular to a plane defined by the circular rim and aligned with the two opposing notches.

6. The spray head of claim 5 wherein an exterior face of the outer rim of the mount is slotted and an exterior of the outer wall of the mount is threaded, wherein rotation of the mount facilitates removal of the mount from the aerator cavity.

7. The spray head of claim 1 wherein the aerator plate is a first aerator plate, the spray head further comprising a second aerator plate retained within the aerator cavity, wherein the first aerator plate is nested within the second aerator plate.

8. The spray head of claim 7 wherein the second aerator plate is configured to be flipped between a first position exposing the first aerator plate and a second position exposing a third spray face.

9. A spray head for a faucet, the spray head comprising:
an outer shell;
a cavity defined within the outer shell;
an outer aerator arranged within the cavity; and
an inner aerator nested within the outer aerator.

10. The spray head of claim 9 wherein the inner aerator includes an inner aerator plate, and the outer aerator includes an outer aerator plate.

11. The spray head of claim 10 wherein the inner aerator plate is configured to be flipped within the outer aerator.

12. The spray head of claim 11 wherein the outer aerator plate is configured to be flipped within the outer shell of the spray head.

13. The spray head of claim 12 wherein the inner aerator plate is an inner aerator disc and wherein the outer aerator plate is an outer aerator disc.

14. The spray head of claim 13 wherein the inner aerator disc includes a first side configured to produce a first spray pattern and a second side configured to produce a second spray pattern, and wherein the outer aerator disc includes a first side exposing the inner aerator disc and a second side configured to produce a third spray pattern.

15. The spray head of claim 14, the spray head including a hose end and a spray end, the spray end including a holder ring with the outer aerator retained behind the holder ring.

16. The spray head of claim 15, wherein the outer aerator includes a convex outer wall extending between the first side and the second side of the outer aerator disc, wherein a diameter of the convex outer wall is greater than an inner diameter of the holder ring.

17. A method of providing different spray patterns for a faucet spray head, the method comprising:
spraying water from a first spray face of an aerator positioned within the spray head, wherein the water sprayed from the first spray face of the aerator has a first spray pattern;
rotating the aerator without removing the aerator from the spray head to expose a second spray face of the aerator; and
spraying water from the second spray face of the aerator positioned within the spray head, wherein the water sprayed from the second spray face of the aerator has a second spray pattern.

18. The method of claim 17, the aerator including an aerator plate with a first side including the first spray face and a second side including the second spray face, wherein rotating the aerator comprises flipping the aerator plate from the first side to the second side.

19. The method of claim 18, further comprising:
rotating the aerator plate such that the first spray face is perpendicular to a rim that retains the aerator plate;
aligning a convex outer wall of aerator plate with two opposing notches on the rim; and
removing the aerator plate from the spray head.

20. The method of claim 17, wherein the aerator is an inner aerator nested within an outer aerator, the method further comprising:
flipping the outer aerator to expose a third spray face and conceal the inner aerator on the spray head; and
spraying water from the third spray face of the outer aerator, wherein the water sprayed from the third spray face of the aerator has a third spray pattern.
